(19) United States
(12) Patent Application Publication
(10) Pub. No.: US 2006/0064352 A1
(43) Pub. Date: Mar. 23, 2006

(54) Strategic business simulation

(76) Inventor: Tay Kim Huat Abel Paschal, Singapore (SG)

Correspondence Address: LADAS & PARRY, 5670 WILSHIRE BOULEVARD, SUITE 2100, LOS ANGELES, CA, 90036-5679, US

(21) Appl. No.: 10/530,649

(22) PCT Filed: May 21, 2003
(86) PCT No.: PCT/SG03/00121

§ 371 Date: Apr. 6, 2005

(30) Foreign Application Priority Data
May 21, 2002 (SG) 200203041-9

(51) Int. Cl. G06Q 30/00

(52) U.S. Cl. 705/26

(57) ABSTRACT

The present invention provides a learning system including a computer assisted simulation of a business environment having at least one virtual marketplace common to all participants in which participants can simulate the trading of processed goods and/or raw materials, each participant having access to a computing means for maintaining a record of their simulated organisation and each participant being able to communicate with other participants. The system includes items representing raw materials, manpower and production facilities, means for participants to review the actions executed in operating the simulated organisation and communication means enabling the individual actions of each participant in operating the simulated organisations to be compared and analysed. The actions of each participant in operating the simulated organisation may be communicated to an instructor as well as other participants thus enabling the participant to understand the result of their actions and decisions and how their decisions could have been modified to produce a better result. Each participant is preferably able to communicate physically and directly with other participants.

### TECHNICAL FIELD

This invention relates generally to a method and system for simulating a business environment to enable participants to interact with the simulated environment to gain a better understanding of those environments. More particularly, the invention relates to a computer assisted simulation of a business environment where participants take turns to make business decisions and observe the result of those decisions.

### BACKGROUND OF THE INVENTION

Despite the prevalence of education, training and books relating to the theory of business, many companies continue to fail. According to some surveys, almost 50% of companies will fail within their first two years, more than 75% of companies will fail in the third to fifth year and only 3% of companies can survive after the first seven years of operation.

The cost of business failure is very high. Beside the fiscal burden placed upon creditors, there is also a human and social cost.

The complexity of a business and the environment in which it operates requires a successful business owner to be very skillful and equipped with substantial knowledge in order for the business to survive and prosper. For these same reasons, it is difficult and costly to provide effective training for business education. The conventional classroom teaching or case study technique is only partially effective in providing sufficient knowledge and skill to business students.

There have been previous attempts to provide learning systems that include simulated businesses and business environments in an attempt to assist business students gain the understanding and knowledge they require in order to avoid business failure. These previous attempts can be classified generally as either:
Manual card/board game;
Board game with paper and pen;
Board game with computer-aided input to replace the paper and pen; and
Computer assisted game with or without the use of an expert system on a Local Area Network or conducted over the Internet.

Examples of manual board games include games such as Monopoly and risk type games. These games are generally simple to play and easily affordable. However, they are generally considered to lack sufficient scope to accurately reflect the real business world.

Examples of manual board games which further introduce the use of pen and paper for recording of results include “Rat Race”, the “Trucking Business” simulation game and finance board games generally. These games primarily teach financial management principles and allow for more complex scenarios requiring the participants to learn the relevant financial management principles in order to succeed at the game.

However, it is generally considered quite time consuming to record and manually calculate results for each participant's turn. Additionally, the requirement to record and calculate results for each turn is error prone.

These types of games are considered to narrowly focus upon the principles of financial management and cause the participants to focus a great deal of their attention on the recordal and calculation of results at the expense of analysing the effect of each participants turn and how the participant's decisions could have been improved to produce a better result.

In order to overcome the specific disadvantages associated with having to perform manual recording and calculation, some business simulation games have been developed that use a personal computer or laptop computer with a customised spreadsheet template such as Lotus 123 or Microsoft Excel for data entry and to maintain a record of transactions.

In some cases the computer completely replaces the role of some or all of the other participants, however in these instances the operation of the game lacks the input of other participants which introduces the “random” effect of other participants' actions in the simulated business environment.

Further, the use of a spreadsheet requires the participants to become knowledgeable of these types of computer applications and may require the participant to purchase a copy of the computer application in order to play the game. In any event, the use of a personal computer significantly increases the cost to a participant wishing to increase their business knowledge and understanding.

In order to facilitate the involvement of multiple participants in games operated using personal computers, interconnected personal computer system games have been developed. The interconnection may be achieved, for example, via a computer network such as a local area network (LAN) or via the Internet. LAN servers or Web servers may be used as a common connection point for all computers involved in the game. LAN server or Web server based computer games primarily represent the board based game on the visual display of the personal computer of each participant and provide for data communications with other machines enabling each visual display to display the position and moves of all the interconnected participants.

In any event, these types of games are usually intended to enable participants to participate in a game without being in close proximity to one another. Accordingly, during play, it is not usual for all the participants to be able to see each other and to communicate personally with each other by a means other than their personal computer.

Computer based systems incorporating an expert system or some form of artificial intelligence have been proposed in order to more accurately reflect the nature of business environments. However, such systems continue to be considered not to accurately mimic the behaviour of human participants, and hence to lack reality. As a result, it is difficult to justify the cost of these systems.

All of these prior art systems are generally considered to be either too complex to operate, too difficult to play, or too restricted in the learning path they provide generally affording students one correct approach which can become very predictable and not accurately reflecting the true nature of business.

Accordingly, it is an object of the present invention to provide a learning system that includes a computer simulated business environment enabling participants of the system to increase their knowledge and understanding of businesses and the business environment generally whilst retaining personal interaction between the participants.

Any discussion of documents, act, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

In one aspect, the present invention provides a learning system including a computer assisted simulation of a business environment having at least one virtual marketplace common to all participants in which participants can simulate the trading of processed goods and/or raw materials, each participant having access to a computing means for maintaining a record of their simulated organisation and each participant being able to communicate with other participants, the system further including:
items representing raw materials, manpower and production facilities;
means for participants to review the actions executed in operating their simulated organisation; and
communication means enabling the individual actions of each participant in operating their simulated organisations to be compared and analysed.

In an embodiment of the invention, the actions of each participant in operating their simulated organisations is communicated to an instructor as well as other participants thus enabling the participant to understand the result of their actions and decisions and how their decisions could have been modified to produce a better result.

In a preferred embodiment, each participant is able to communicate physically and directly with other participants.

In another aspect, the present invention provides a method of business learning including computer assisted simulation of a business environment having a virtual marketplace common to all participants in which participants can simulate the trading of processed goods and/or raw materials, each participant having access to a computing means where each participant maintains a record of their simulated organisation and each participant being able to communicate with other participants, the method including the steps of:
simulating the business environment in cycles where each participant takes a turn, and, at the commencement of a cycle, information relevant to the business environment is communicated to each of the participants and each participant takes individual turns to effect actions in an attempt to optimise the value of their simulated organisation for that cycle;
recording each participant's action in the computing means; and
communicating the actions of each participant with all other computing means,
such that the actions of each participant may be analysed and compared with the actions of other participants.

Preferably, at the completion of a round (about 12 to 15 cycles or an hour of simulation that equates to a Fiscal Year), the system and method provides to each participant a report of the status of the business environment and the result of the participants actions during the previous round. During each round, participants may be presented with one or more opportunities to make decisions, and on each such occasion a participant may be presented with a learning message prior to committing to a decision. In a particularly preferred embodiment, an experienced business person or instructor assists the participants to understand the result of their decisions during the previous round and how their decisions could have been modified to produce a better result. It is particularly useful if participants are able to communicate with one another directly. However, it is possible that communication between participants could be effected by video conferencing; telecommunications or electronic mail. Communication between participants and the instructor could also be effected by similar means.

Of course, the system preferably represents a competitive market place that reflects present day trading conditions and constraints. The learning system may also include diagrammatic displays that assist participants to track their simulated organisations such as a stylized map of the world to enable participants to monitor the location of assets owned by their simulated organisation. In a preferred embodiment of the invention, physical items representing different types of assets are placed onto a stylized map of the world to represent the acquisition and location of an asset in the world.

Each participant would usually take it in turns to make a business decision. Preferably, the current market conditions for each cycle are indicated to all of the participants to enable them to make business decisions in the full knowledge of the market risk present during that round. Each simulated organisation will generally purchase raw materials from the market and process those materials through a planning and design stage followed by a processing and packing stage. Subsequent to these stages, the raw materials are then viewed as finished goods and may be sold to the market as a product for consumers. The production and processing stages are dependent upon the processing facilities and manpower available to the simulated organisation and these must also be acquired along with the required raw materials.

In the preferred embodiment of the learning system, the finished goods sold to the market are recycled into raw materials. The success or failure of the simulated organisation will depend upon many factors that must be taken into account by each participant. For a sale of finished goods to the market place, only the lowest bidder is usually considered to be successful in order to achieve that particular sale. In a particularly preferred embodiment, an item is also provided to represent services.

Preferably, during simulation, participants can invest in core competencies of the organisation and outsource extraneous aspects of the organisations operation.

In a preferred embodiment the learning system provides participants with different sized markets with different sets of minimum buying costs for raw materials and maximum selling prices for finished goods. In this embodiment, there are also different prices for land and set-up costs for external branch offices and participants may purchase each for purposes of using these assets to increase the overall value of the simulated organisation. Of course, as occurs in real life, the assets owned by each participant's simulated organisation may be subject to risks that are beyond the control of each participant.

Each participant's computing means preferably monitors all resource and activities of the simulated organisation and actions taken by the participant.

Each participant may use a stylized map of the world, which has been given the name “World of Resources” or WOR, to track their simulated organisations resources and assets such as Research and Design facilities, processing equipment, available raw materials, stored finished goods. Preferably, each participant is able to take steps to implement security procedures such that theses types of resources and assets are hidden from other participants. Each participant may also outsource elements of an organisations operations and invest in fixed assets, these types of assets and arrangements preferably not capable of hiding from other participants.

In a preferred embodiment, each participant may obtain a loan from a central bank using electronic money which may be controlled by the instructor. Credit limits placed upon each participant may be associated with the performance of the participant during a previous round.

Preferably, upon completion of a round, data is exported from the participants computing means and communicated to a central computing means. In a particularly preferred embodiment, the central computing means performs analysis of the data received from the participants' computing means, and is able to generate reports that may be used by the instructor and/or the participants to analyse the participants' performance in the simulation. In particular, the reports may be analysed by the instructor to determine which actions led to particularly good or bad results. These actions may then be explained to the participant, or to the group, and discussed to determine why the action was particularly good or bad and how the action could have been modified to produce a different result.

The reports that the central computing means is able to generate may include:
a) reports on participants' performance during any past or the current fiscal term of the simulation;
b) reports comparing the year on year performance of a single participant;
c) reports comparing the participants' performance and market share during a single fiscal term;

The reports may further include charts comparing selected performance factors either:
a) between different participants during the same fiscal term;
b) between different fiscal terms for the same participant.

The performance factors that are preferably available for selection include:
a) accumulated earnings;
b) average price;
c) balance available;
d) break even point ratio;
e) cash reserve;
f) equity ratio;
g) market share;
h) retained earnings.

In a particularly preferred embodiment, the computing means used by the instructor and by each participant is a Pocket PC or Personal Digital Assistant (PDA) which is operable to display various types of information relevant to the learning system and receive instructions from each participant with respect to actions in accordance with business decisions taken by each participant.

Advantageously, the computing means of the instructor and the participants are further operable to retrieve selected reports from the central computing means, and to display corresponding charts on a display of the computing means and/or to print the reports using an associated printing means.

In the preferred embodiment in which the central computing means is an Internet Server, the computing means of the instructor and participants is ideally equipped with wireless communication means supporting connection to the Internet for communication with the central computing means. The associated printing means may be a printer accessible via the same or additional wireless communication means, such as for example an IrDA connected printer.

Preferably, each participant receives a comprehensive debrief from the instructor with respect to the performance of their simulated organisation.

In a preferred embodiment, the central computing means is programmed to maintain information relating to more than one simulation at any given time.

Preferably, the central computing means is operable by authorised users such as instructors or other facilitators.

Advantageously, each of the users is initially required to register as an operator of the central computing means in order to become authorised. A registered operator may be subsequently identified using a code allocated upon registration, such as a member identity number.

Preferably each registered operator is able to operate a predetermined set of features of the server. In a particularly preferred embodiment, the set of features available to the operator can be limited depending upon the operator's identity so as to provide different levels of access to different operators of different status.

Advantageously an access level is provided corresponding to the status of an instructor or other facilitator of a simulation. An operator granted the access level of an instructor or other facilitator of a simulation is preferably able to operate the central computing means to schedule a simulation to occur at a specified time. Ideally, when scheduling a simulation, the operator will specify information regarding the simulation including the date and time of commencement of the simulation, the number of participants, and the computing means to be allocated to the participants for the duration of the simulation.

In a particularly preferred embodiment, a cost is associated with each simulation representing a price to be paid by each participant in order to participate in the simulation. Ideally, the central computing means maintains a virtual account for each user with the status of an instructor or other facilitator. The account may contain points corresponding to monetary payments, and the number of points in the user's account is checked to confirm that the user is authorised to create the scheduled simulation. If the user has insufficient points, then the simulation will not be scheduled.

Advantageously, prior to activation, a scheduled simulation may be cancelled, modified or activated by an authorised user. However, once a simulation has been activated, preferably it can no longer be modified or cancelled and it will subsequently be created at the scheduled time. Once a simulation is created, participants may commence their participation in the simulation.

In a particularly preferred embodiment, the central computing means is an Internet Server which is operable by the registered operators via computing means connected to the Internet and running a web browser application. More particularly, the registered operators may connect to the Internet Server using the web browser and operate it by entering information into web forms served by the server.

“Comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

One embodiment of the invention will how be described with reference to the accompanying drawings in which:

FIG. 1 is a diagrammatic representation of a typical learning environment for six participants and an instructor;

FIG. 2 is a diagram representing the learning stages for a session lasting for the equivalent of five fiscal years;

FIGS. 3A and 3B show two example market rings;

FIGS. 4A and 4B show an example Front-End System introductory screen in two different languages respectively;

FIG. 5 is a Front-End screen displaying participant “resources”;

FIG. 6 is a Front-End screen displaying available participant “actions”;

FIG. 7A is a Front-End screen displaying a “Food for Thought” message;

FIG. 7B is a Front-End screen displaying participant “decisions”;

FIG. 8 is a Front-End screen displaying to a participant the state of the market representing the level of “risk” prevalent in market conditions;

FIGS. 9, 10 and 11 are example Front-End screens displaying a message to a participant, the cost associated with the message, and the result of that message and cost respectively;

FIG. 12 is an example introductory screen in a web-based Back-End system accessed using a web browser;

FIG. 13 is an example web form enabling a user to sign up for access to the web-based Back-End system;

FIG. 14 is an example of the main options screen provided to a user by the web-based Back-End system;

FIG. 15 is an example of a form provided by the Back-End system to enable a user to create a new business simulation event;

FIG. 16 is an example of a form provided by the Back-End system to enable a user to select the personal computing devices to be allocated for use during a business simulation event;

FIG. 17 is an example of a web page provided by the Back-End system confirming that a new business simulation event has been created;

FIG. 18 is an example of a web page provided by the Back-End system enabling a user to check current points balance;

FIG. 19 is an example of a web page provided by the Back-End system enabling a user to view previously created business simulation events;

FIG. 20 is an example of a web page provided by the Back-End system showing details of a previously created business simulation event;

FIG. 21 is an example of a web page provided by the Back-End system to enable a user to modify the details of a previous created business simulation event;

FIG. 22 is an example of a web page provided by the Back-End system for the user to modify the personal computing devices allocated for use during a business simulation event;

FIG. 23 is an example of a web page provided by the Back-End system to enable a user to delete a previously created business simulation event;

FIG. 24 is an example Front-End screen showing a menu of options available to an instructor or participant;

FIG. 25 is an example Front-End screen showing Internet Auto-Loading options;

FIG. 26 is an example Front-End screen showing communications connection options;

FIG. 27 is an example Front-End screen enabling a participant or instructor to select a report for download from the Back-End system;

FIG. 28 is an example Front-End screen enabling a participant or instructor to select a graph for download from the Back-End system;

FIG. 29 is an example Front-End screen showing a menu of options available to allow a participant or instructor to view charts or print reports using data previously downloaded from the Back-End server;

FIG. 30 is an example Front-End screen enabling a participant or instructor to select a specific chart to view;

FIG. 31 is a graphical representation of a bar chart showing the balance available to each participant at the end of a fiscal period;

FIG. 32 is an example Front-End screen enabling a participant or instructor to select a specific performance analysis report for printing;

FIG. 33 is an example Front-End screen showing selection of a printer for printing of a report.

FIG. 34 is a “World of Resources” chart indicating the types of resources available to each participant;

FIG. 35 is a “World of Resources” chart as depicted in FIG. 34 annotated with text providing additional information relating to the resources;

FIG. 36 is a drawing representing the core business model of an embodiment of the learning system;

FIGS. 37 and 38 are reference charts of a preferred embodiment summarising the resources, actions, decisions and incidents; and

FIG. 39 is a list of the fundamental rules of a preferred embodiment of a business learning system according to the present invention.

### DESCRIPTION OF A PREFERRED EMBODIMENT

The following provides a detailed description of a method according to the present invention.

In the preferred embodiment, a computer-based Learning System is implemented using two major software components. These two components are the Front-End system and the Back-End system. Together they operate to record and analyse the actions of participants in a simulated business environment. A particular business simulation involves a group of participants and usually an instructor, and is run for the purpose of enabling the participants to learn important principles involved in the operation of a business. For convenience, such a business simulation exercise is also referenced herein as an Event.

The Front-End system is a software system that participants and instructor use during the course of an Event to enter information relating to their selected business actions, and to interact with the Back-End system. The Back-End system gathers information from all the participants' actions, and processes it in order to assist the instructor and participants in analysing the results of the participants' actions. In the preferred embodiment, the Front-End system is designed to execute on a hand-held Pocket PC or Personal Digital Assistant (PDA), which has the advantage of enabling the participants to enter information into their own devices while sitting together, for example around a table in a single room, without the interference of bulky desktop computer systems limiting their ability to interact personally with one another. The Back-End system executes on a separate remote computer system, which is accessible via the Internet, and may therefore be located anywhere in the world. Connectivity between the participants' PDAs and the remote Back-End can be, for example, via a wireless link to a local area network which is connected to the Internet, or via some alternative wireless access method.

When the Learning System is installed and configured ready to start on the Front-End and Back-End systems, the normal process of an Event consists of the four stages of Planning, Deployment, Monitoring and Analysing.

In the Planning stage, the Instructor introduces the participants and familiarises them with respect to basic operation of the Learning System. Typically, each participant will have his or her goal and vision. Each participant will generally have some idea in his or her mind as to how they intend to participate and may have a formal plan before any action take place.

The Deployment stage is the part of the learning method in which the participants interact with the business environment and make decisions. This stage consists of a number of rounds of simulation of the business environment. Every business environment presents risks as well opportunities, and depending upon each participants' experience, knowledge and vision they will generally make different decisions during each round of the simulation. Any decision is entered into the Front-End System on an individual Pocket PC by the participant. The consequence of all the actions of the participants is accumulated into the results of the simulated business environment.

The Monitoring stage is entered after a predetermined period of time expires or the maximum number of cycles for a round is reached. Participants export the data in their PDA relating to their activities during that round to the learning system Back-End for processing and analysing. A Participant Performance Analysis (PPA) report is then generated to provide the participants with an indication of the success or otherwise of their decisions in that round. In a particularly preferred embodiment, the period of time for a round represents one fiscal year with respect to the simulated business environment.

In the Analysing stage, the instructor guides the participants in interpreting the PPA report. The report includes an Accounting Statement and the instructor may provide explanations of the meaning of each Accounting Ratio in the PPA report. Based on the results in the PPA report and through observation, the instructor should be able to determine good and bad decisions made by the participants in the previous round. By comparing the results and analysing the actions taken by each participant, and advising the participant how to make better decisions, the Instructor is able to help the participants to learn to make better business decisions.

The simulation continues for a full session until the expiration of a previously agreed period of time or number of cycles. Due to its highly interactive nature, the Learning System supports many different learning methods by the participants. Some of the learning methods by which participants improve their business knowledge and skill include direct communication between participants, mentor coaching, learning from peers, and hands-on active learning. These are discussed in more detail as follows.

Direct communication between the participants provides active interaction and helps to maintain interest in learning. The learning system may accommodate 4 to 12 participants on a meeting table in a small group environment. The learning system may also promote personal networking amongst the participants.

Traditional coaching by a mentor is a well-established technique to pass on or share knowledge. The learning system benefits from an experienced consultant, lecturer or business leader acting in the role of the instructor. However, expert participants could effectively learn from one another.

Learning from a peer through observation of their success and failure is a common method to improve oneself. The learning system provides an environment for competition and challenge between participants. It is by careful observation of people, their facial expressions, eye and body movements that participants learn to develop a better insight to a person and their character.

Learning is an active process, and with “hands-on” experience participants will learn and retain those experiences more effectively than reading or studying principles. Participants are actively involved with mental and physical activities to learn. The learning system allows each participant to manage a company, make their own decisions in response to simulated business situations and monitor the outcome during the process. Beside the recommended five cycles/years of exercise, participants can partake in sessions of the learning system over and over again.

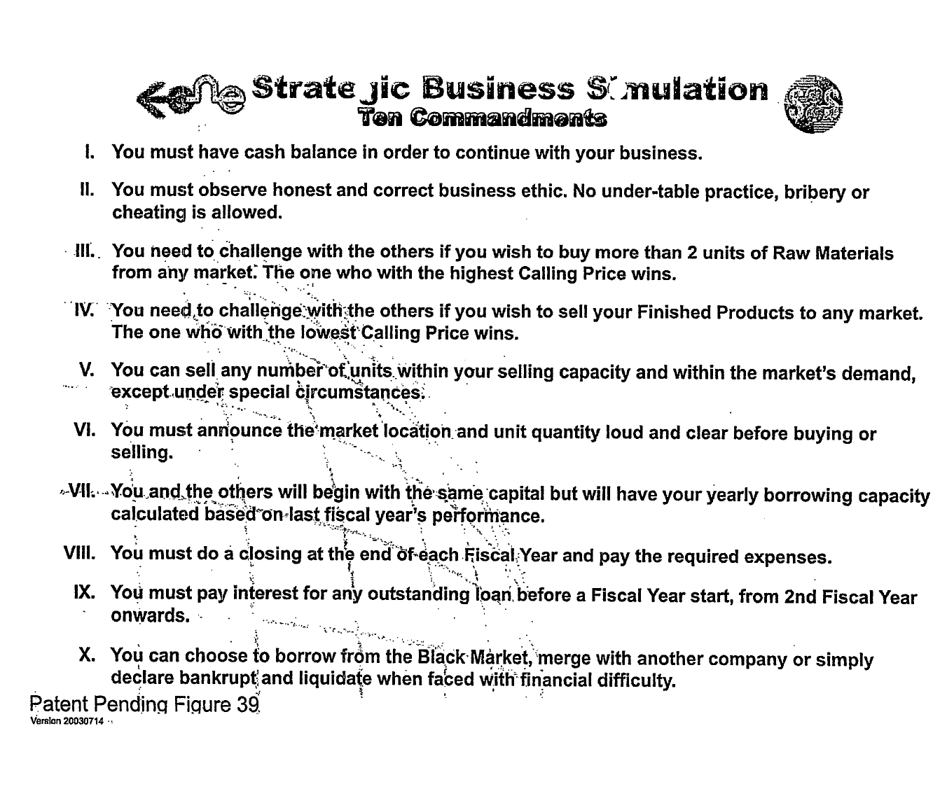

The learning system is also designed to encourage participants to develop a fair and ethical approach to their business interactions with others. A fair system for competition is an environment that will encourage participants to progress and advance. The learning system's rules and regulations require participants to adopt a correct attitude to compete in an open market without seeking government protection or engage in illegal practices. Even though unethical business practices may occur in the real business world, these are not encouraged in the learning system. Rather, participants are required to follow ten fundamental rules, or “Commandments”, of the learning system, as set out in a list made available to all participants as depicted in FIG. 39.

Learning is best encouraged by a systems that is interesting and includes elements of fun. Learning through operating a simulated business helps to retain participants enthusiasm while learning business skills. In the preferred embodiment, the learning system uses physical items to represent resources needed in the business world. These items provide a better visual impact reinforcing the participants' sense of ownership and personal investment in the progress of the business, adding to their excitement and interest and helping them to enjoy the learning process.

Using a computer as a tool to learn has been proven to be effective and efficient. As previopusly described, in the preferred embodiment, the learning system uses PDAs to computerise participant activities. The participant PDA Front-End Systems are interlinked with an Internet Server Central Computing Back-End System for consolidation of all participant transactions and data to provide reports and provide comparison charts for result sharing and analysis. Consequently, participants are free to focus on their business strategy without worrying about the manual recording and calculating of transaction data.

The operation of the learning system outlined above will now be described in greater detail.

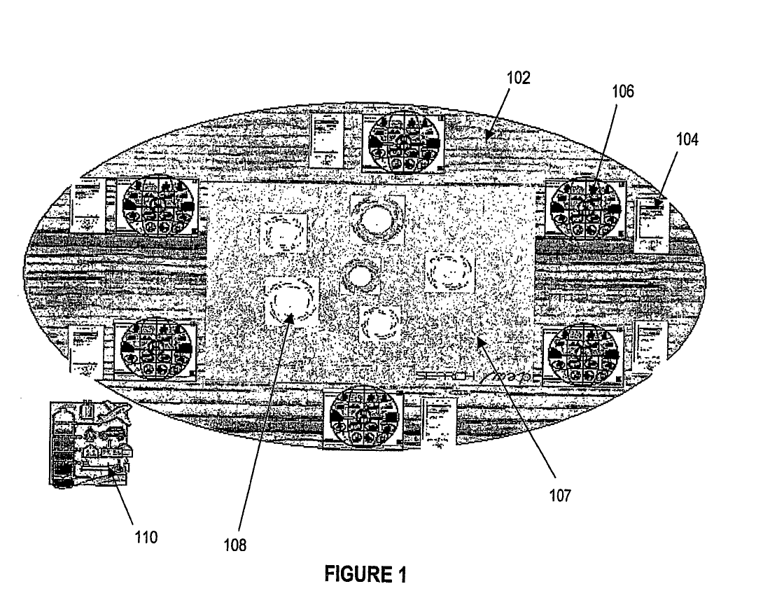

FIG. 1 illustrates diagrammatically a typical learning environment for six participants. As shown in the figure, the participants sit around a table 102, each participant being provided with a PDA e.g. 104, and a “World of Resources” chart e.g. 106. The World of Resources chart is described in greater detail later in this specification. At the centre of the table is a map 107 which represents a geographical region corresponding to the simulated business environment. On the map are placed a number of Market Rings 108, which represent market conditions in corresponding parts of the geographical region, as discussed in greater detail below. Additionally, a number of items 110 are provided to represent resources in the simulated business environment.

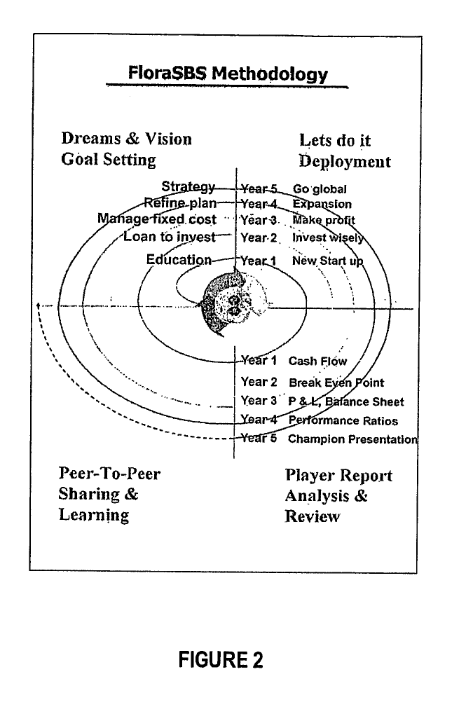

FIG. 2 represents the learning stages through which participants progress over the course of the Event. The preferred simulated term of an event is five fiscal years, enabling the participants to learn through experience of the five stages of the business development shown in the figure. In the first fiscal year, the participants' goal is to learn about the business environment, which is achieved through the establishment of a new start up company. At the end of the first fiscal year, the focus of the report analysis and review is on the cash flow of the new company. In the second fiscal year, the participants' goal is to obtain a loan to grow the business through wise investment, and the report analysis and review is focused upon reaching a break even point for the business. In the third year, participants learn to manage costs by striving for profitability, and the review is directed towards profit and loss and balance sheet analysis. In the fourth year, participants refine their business plans in order to achieve expansion of the business, and analysis is directed towards accounting performance ratios. In the final year of the Event, participants refine their strategies in order to take their businesses global, and are expected to be able to participate in advanced analysis and review of their performance.

The World of Resources chart 106 provides spaces for participants to place their key Resources chips and Models 110 from the Facilitator, which represent the status of their business visually. It also acts as a subconscious education tool for participants to learn and become familiar with the place of their simulated business in the world, and develop a global view. In the era of global communications, globalisation and very competitive market environments, it is important for business people to have a global vision.

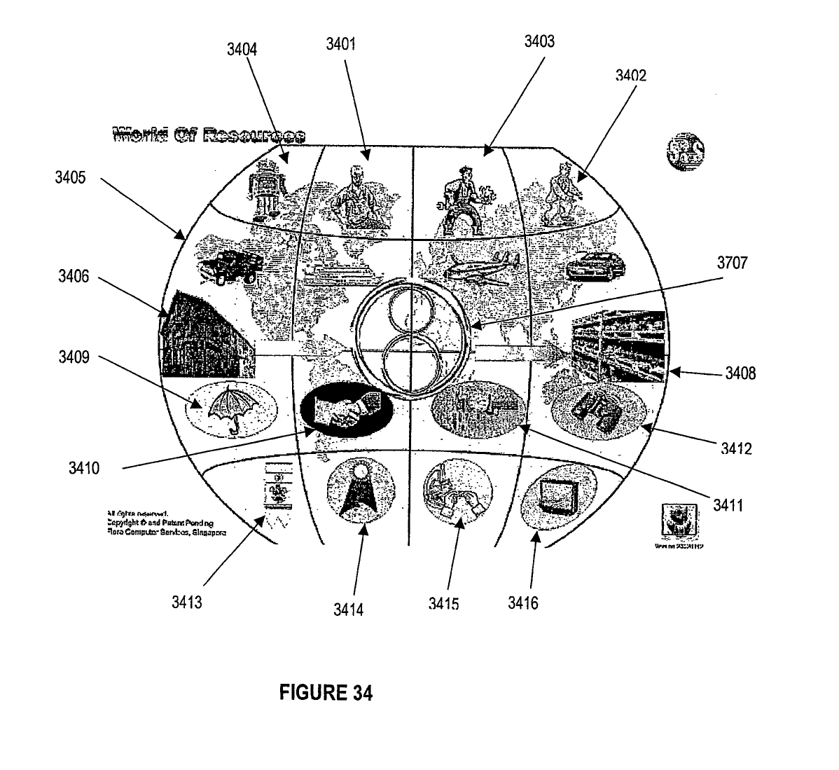

The World of Resources chart is shown in greater detail in FIG. 34. The northern hemisphere includes human resources, in reflection of the global reality since the north is more heavily populated than the south. Human resources play the most critical role in business operations today. The core human resources are the workers 3401 and salesmen 3402, without which business could not function. Human resources also include contracted temporary staff 3403 to meet the dynamic needs of the business operation. The cyber human 3404 represents the information systems that have become an integral part of business today.

North of the equator is the ring of capital investment 3405 that participants must consider carefully before making a commitment.

The production process starts with raw materials in place at the warehouse 3406, shown on the left side at the equator. With machines and manpower in place at the factory 3407 in the centre, a process of moving materials from left to right ensues. The finished goods are kept in the store 3408 on the right side of equator ready for sales. Cross-equator processing symbolises today's manufacturing environment which occurs across many countries and involves many stages, as all of the world's economies are mutually dependent upon each another.

South of the equator is the ring of short-term investment items such as insurance 3409, purchasing agents 3410, work improvement programs 3411, and customer service 3412. These services may be needed prior to making investments as and when required to support business operations. Southern hemisphere items include the important investments that support marketing and long term business needs such as Brands 3413, Charitable Contributions 3414, Research and Development 3415 and Marketing Campaign 3416.

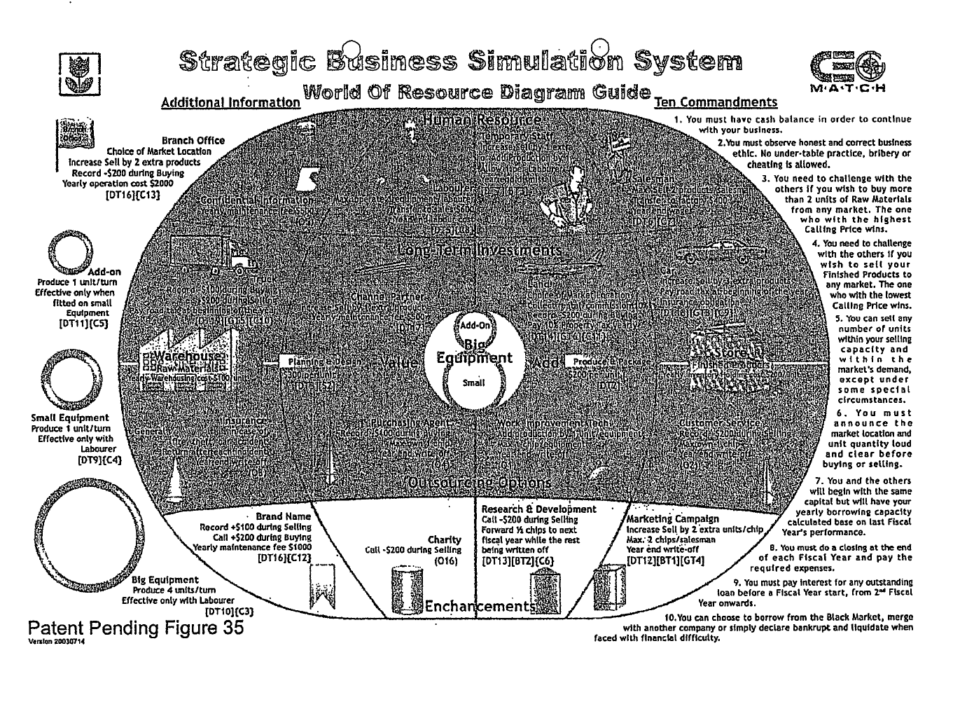

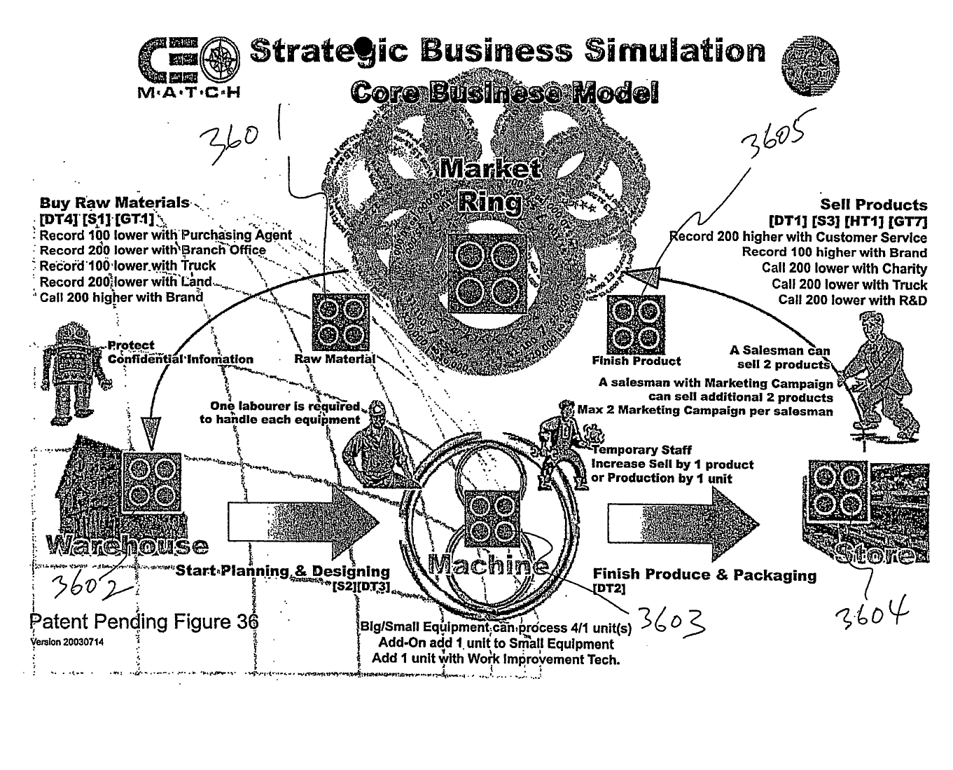

FIG. 35 depicts an annotated version of the World of Resources chart which is available to participants to serve as a reference to the meaning and use of the various spaces in the World of Resources.

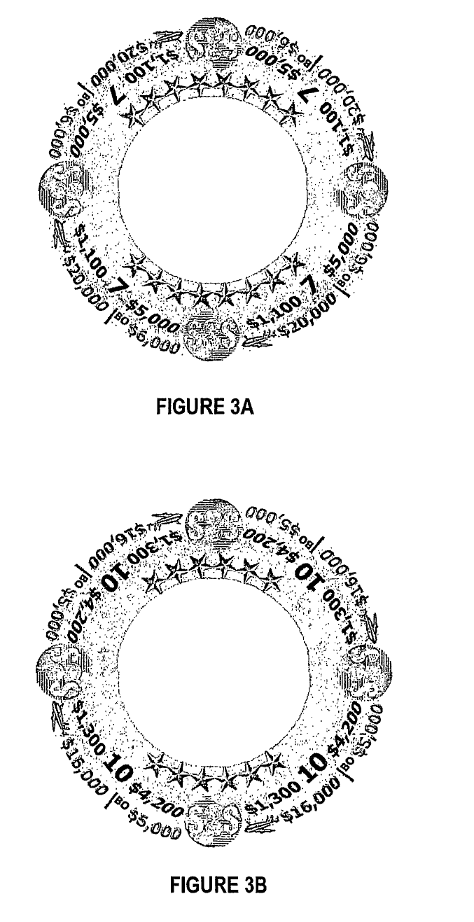

A further key feature of the learning system are the Market Rings 108, of which two examples are depicted in greater detail in FIGS. 3A and 3B. There are at least seven market rings of similar shape and appearance which are used in the learning system to represent the marketplace for business. Placing the rings on a given map e.g. 107, whether it is a world or local map, defines the characteristics of the business territory for the current session. Each marketplace has it own character and constraints that are reflected as figures on the Market Ring. These characteristics include the product Price Range, Market Size, Land Value and Branch Office setup cost. The total marketplace is thus differentiated into territories spanning the highest to the lowest end of the market, which are ranked by the number of stars on each market ring to reflect the different market segments. Each market ring is applied to the map to as to physically and symbolically surround and limit the market, so that the city, state or other location name on the map will be appear within a market ring. Market rings can be used to define the market conditions in places such as Singapore, United Kingdom, United States of America or China, for example. Participants need to identify and announce the name of the market place for their buy or sell actions so that other participants can react accordingly.

The above described features, including the map 107, the World of Resources chart 106, the Resource items 110 and the Market Rings 108, implement the core business model of the learning system. This model is depicted in FIG. 36, which shows how the various components of the learning system facilitate the overall cycle of production simulated by the system. Raw materials 3601 move to warehouse facilities 3602, from which they enter into production within the factories 3603. The resulting products are moved to storage 3604, from which they are sold to the market as finished products 3605.

At the end of each round, normally representing one fiscal year, the transaction data from the participants' PDAs are uploaded to the Back-End system. The Back-End program merges all participants' data into a database and generates a comprehensive Participant Performance Analysis (PPA) Report for each participant. The report provides a summary of results for the participant to review their performance of the year of operations. The PPA Report includes information such as borrowing capacity, opening payments, performance analysis, accounting ratios, transaction summary, unit value, income statement, balance sheet, and year end resources status, as discussed in greater detail below.

The borrowing capacity information in the PPA allows a participant to understand their coming year line of credit to the bank based on their current year performance.

This opening payments section of the PPA reflects the financial commitments and payments that must be made at the beginning of a new financial year in addition to other operating costs.

The performance analysis section of the PPA informs participants of the break-even point of their business.

The PPA includes all the accounting ratios commonly used by finance analysts, shareholders and business owners to make a quick comparison between companies' performance and their potential.

The transaction summary included in the PPA lists the total input and output of each business.

The PPA includes unit value, which is the average price/cost base for the business on accumulated pre year transactions.

An income statement is also provided in the PPA, which includes a simplified Profit and Loss statement based on the transactions occurring during one round or fiscal year. A ranking and best result among all the participants is also provided. A brief analysis of this aspect of the report enables a participant to determine their strengths and weaknesses and to determine their current position at the commencement of the next fiscal year.

The balance sheet section of the PPA is a statement of the assets and liabilities of the business. Ultimately a business owner must consider their bottom line which is reflected in their Balance Sheet.

The company resource status in the PPA enables participants to keep a historical record of the year end closing, thus allowing them to review and analyse their yearly performance.

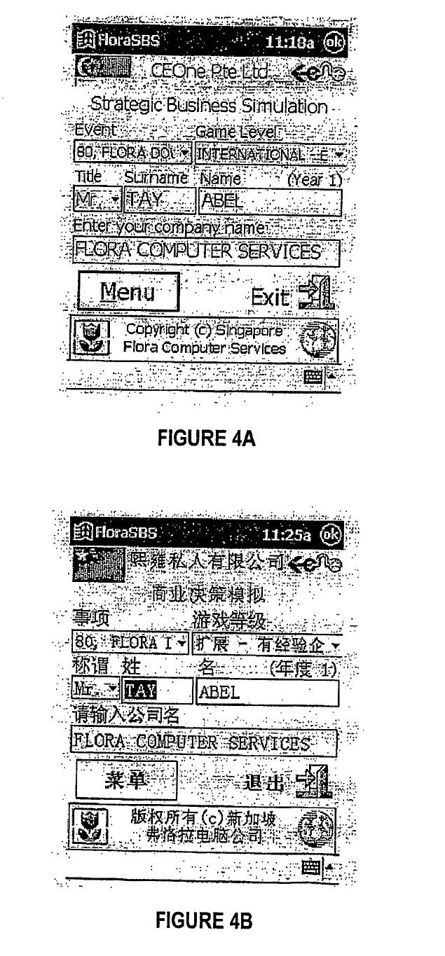

The description now turns to the Front-End system used by the participants during the activities of the learning system described above, with reference to the accompanying FIGS. 4-11. As previously mentioned, the Front-End system is implemented on PDA devices, and the figures show some exemplary display screens according to the preferred embodiment of the system.

The Front-End System program provides data collection tools aimed to be simple and easy for participants to use without any prior computer training or knowledge. The PDA Front-End Program is capable of displaying multiple languages allowing participants to choose their preferred language. This multi-lingual capability is illustrated by FIGS. 4A (English) and 4B (Chinese) respectively.

Primary functions of the program are to provide for simple selection of business actions and allow simple data entry for transactions needed in simulated business operations during a session. The Front-End program supports up to five participants with multiple skill levels, so that one common device may be shared by a group of participants.

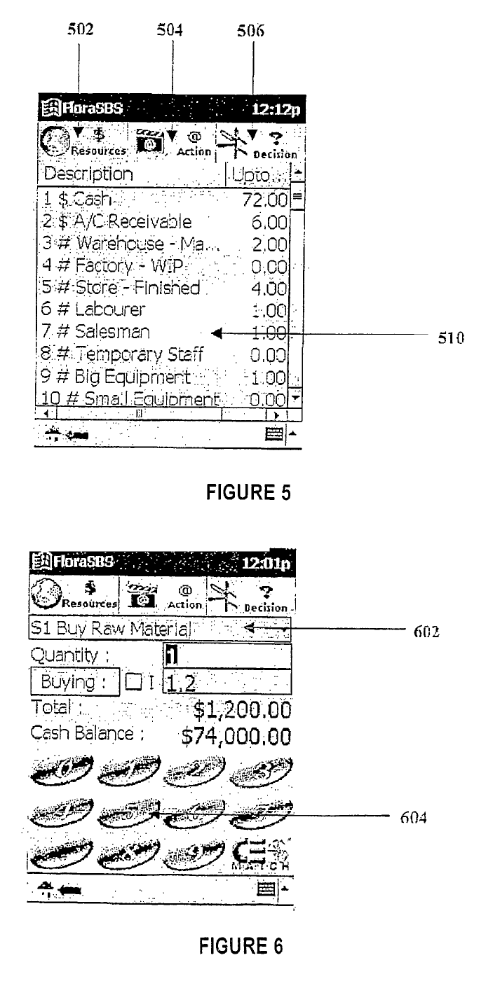

The Front-End program performs two major functions. Firstly, the Operations area provides all the functions needed to simulate a business environment during a session. Secondly, the Support area provides utility functions such as “exporting” data collected during sessions, “deleting” existing records on participants' Pocket PC's “summary reports” and others. During a round, participants interact mainly with the Operations area, and a number of Operations screens are illustrated in FIGS. 5-11.

The simulated business operations include four major components, namely, Resource, Action, Decision and Risk. In the preferred embodiment, the first three of these four components are accessed by each participant using the tabs 502, 504, 506 with corresponding labels, as indicated in the sample display of FIG. 5, and the selected components are displayed in separate panes corresponding to the selected tab. Risks arise when selecting the Decision Tab during Turbulent Time market conditions. The currently selected tab, e.g. the Resource tab 502 in FIG. 5, is highlighted in a visually distinctive manner to enable the participants to clearly recognise which component they are currently operating within. A different colour interface is also used for each component to assist participant recognition. The contents of each component will now be discussed in greater detail.

The Resource pane is illustrated in FIG. 5. Resources are logically listed within the lower pane 510 for easy reference. Regular updates to the status of company resources after each transaction are displayed. This function simulates a Simplified Company Computerised System and the balance shown should tally with the Physical unit count appearing on the World of Resources chart for each Participant. Since cash is one of the most important items among all the Company Resources, it is displayed on the top of the list. The learning system does not use real currency. Regular updates of the cash balance are also displayed after each transaction takes place.

An Action pane is illustrated in FIG. 6. This component categorises normal business actions such as Supplement Actions, Optional Move Actions, Actions to settle normal transactions, Beginning Year business opening Actions, Combine or acquisition Actions, Duty or obligation Actions, End of Year Closing Actions and others. Participants are given the freedom to choose what Actions they are going to take and are limited to one for each session except for commencing a business and End of Year Actions for Closing Business Accounting. In the preferred embodiment, the desired Action is selected from a drop down list 602.

Depending upon each type of Action, participants may need to enter a Quantity and/or Value, for which purpose a keypad 604 is provided. The Program will carry out computation and provide real time verification upon confirmation by the participant. Transactions are recorded and related resources are updated immediately.

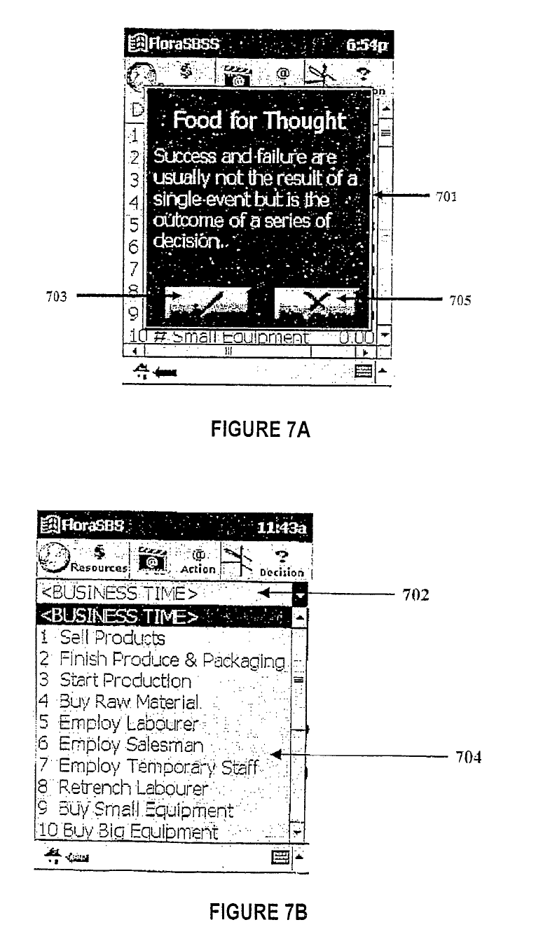

Each participants is given an opportunity to enter the Decision function by selecting the Decision tab once in each session. However, when the Decision tab is selected the Decision pane does not appear immediately. First, a function known as “Food for Thought” is activated, which presents the user with a pop-up window 701 as shown in FIG. 7A. The “Food for Thought” window contains an educational message that is randomly selected from a set of available messages. The “Food for Thought” function therefore serves to provide additional learning material, however it also performs the additional function of preventing the participant from accidentally entering the decision function. When the “Food for Thought” window is displayed, the participant has the option of selecting the “check” button 703 to enter the Decision pane, or selecting the “cross” button 705 to abort entry into the Decision function.

A Decision pane is illustrated in FIG. 7B. The front-end program provides programmable control to simulate different business climates such as Good Times, Bad Times, Business Times, Harvest Times and Turbulent Times, these names indicating defined current market conditions. In the preferred embodiment the current conditions are displayed in a text field 702 at the top of the pane. For each market condition, different sets of options are presented to the participant to select from the list 704 of business decisions which is displayed below the text field.

The program provides real time checking to verify whether a participant has the basic required Resources to perform the desired Action. Standard Business rules and conditions are used in the program to minimise human errors and at the same time to educate the participant for what must be done or required before taking each type of Action.

Similar to the Action function, the particular Decision function to choose is a major issue that a Company owner needs to decide from time to time. After a decision has been made, the participant selects the action and the transaction details are recorded and updated.

Some decisions made by a participant, such as buy or sell, could increase competition in the market and may be challenged by other participants. Accordingly, other participants may forward a better offer and the participant who eventually makes the best offer is able to input the transaction.

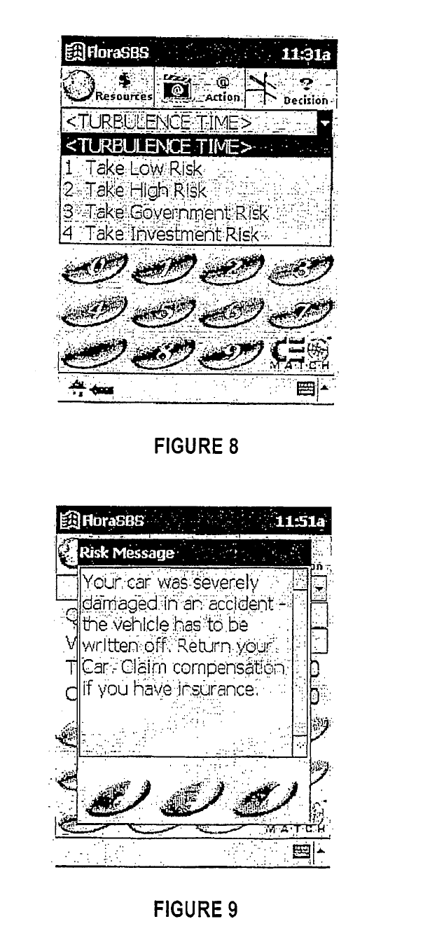

As previously mentioned, risks arise when selecting the Decision Tab during Turbulent Time market conditions. As depicted in FIG. 8, each participant is provided four different types of risk to choose from, which are Low Risk, High Risk, Government and Investment Risk.

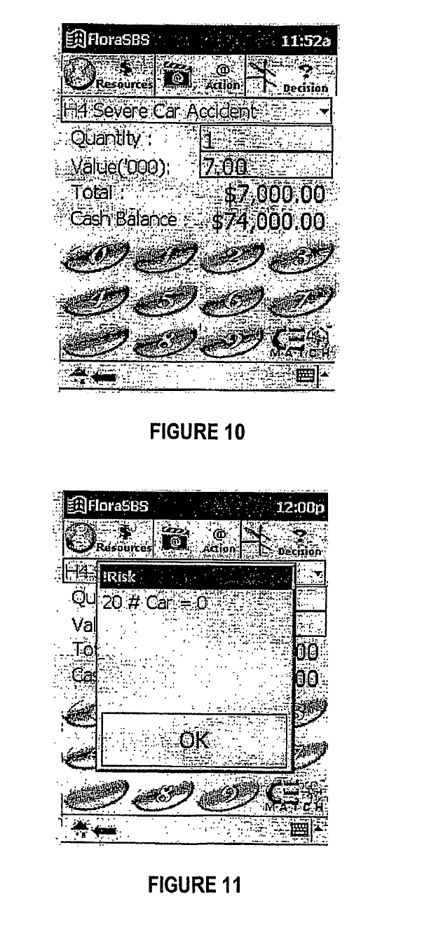

Unlike the options provided in relation to the Decision tab, participants will not be given any choice under the selected type of Risk function. Messages are presented to participants depending upon their current status and participants may be forced to take certain actions. Transactions will be updated accordingly. For example, FIG. 9 depicts a display in which a participant is informed that a company vehicle has had to be written off, resulting in a need to make an insurance claim (if applicable). This event affects the resources owned by the business, and the participant will be required to make corresponding transactions accordingly, as depicted in the display shown in FIG. 10. If the transactions encounter a problem, the Front-End program reports to the error to the participant via an error message, as shown in the display of FIG. 11. In this case the Front-End program shows that there is no car owned by the participant, and thus he or she is not affected by the risk problem presented.

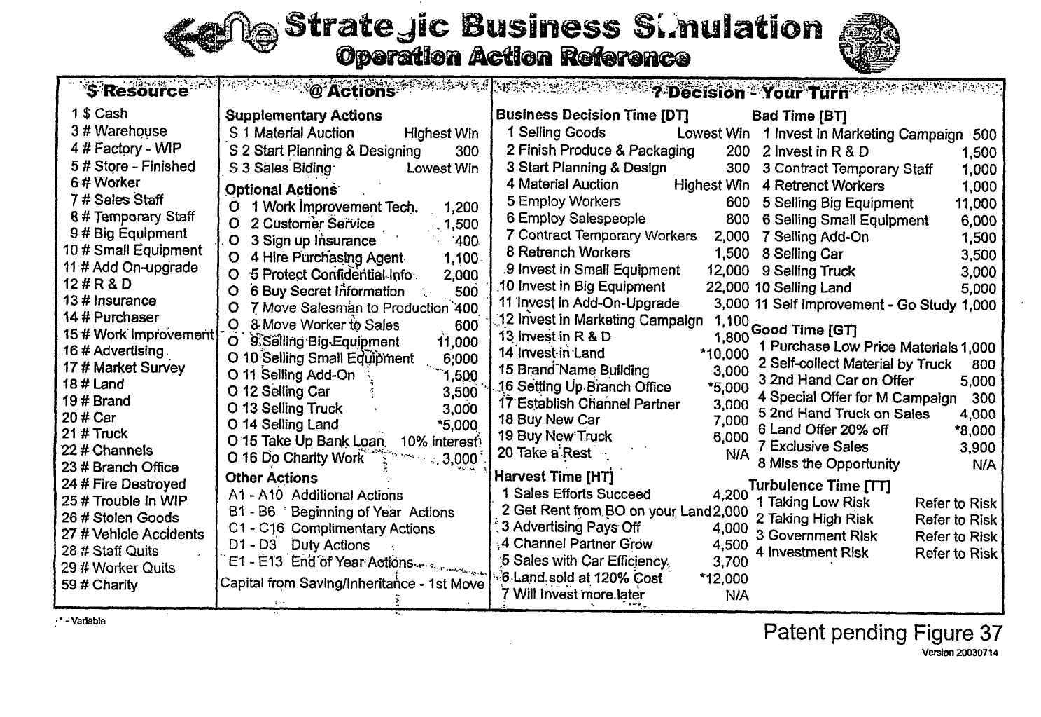

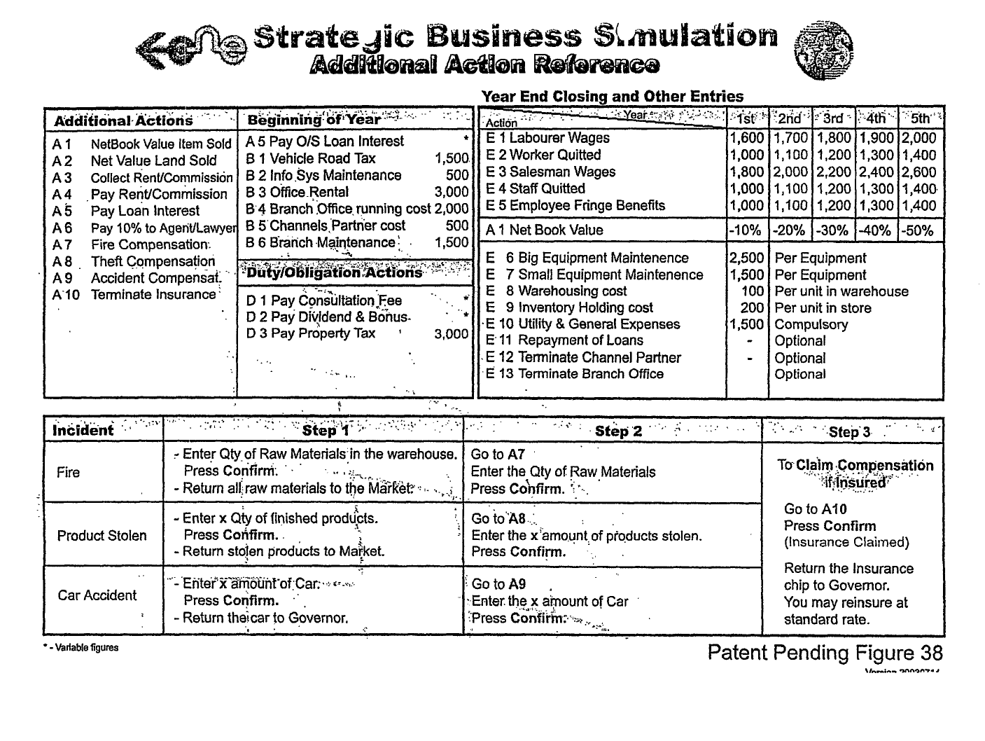

The Operations area supports many different functions, of which the above described are only a small number of exemplary cases. In order to assist the participants in accessing the desired function easily, Operation Action Reference cards, such as those depicted in FIGS. 37 and 38, are preferably provided.

In a particularly preferred embodiment, text to speech technology is incorporated in the front end system which is used to convert messages presented to the participant into audible speech. This gives other participants the opportunity to hear the messages presented to a particular participant thus affording them an opportunity to learn the types of common risks that can arise in business which may or may not occur during their own operation of their simulated business.

The Back-End System program is used to manage Events, and for data consolidation for all participants. In the preferred embodiment it is executed on an Internet Server Central Computing Back-End System.

The learning system may be leased with revenue being generated from users each time they participate by using the Front-End System in their training class, workshop or seminar. This approach represents a “Pay As You Use” business model. The Back-End system is integral to the implementation of this model. The Back-End System may be located in an Office in Singapore and the Front-End System may be licensed to regional operators, called “Channel Partners”, to operate any place around the world with Internet access. A Channel Partner can be an independent consultant, Company or any Organisation that wishes to use the learning system to complement their training programs.

As part of the process, selected Channel Partners would need to invest in at least 8 sets of the Front-End Systems, i.e. PDAs with the Front-End software installed, complete with all the necessary components such as training kits manuals, user guides etc. The total investment covers the cost of training for two staff, system support for the Front-End operations, Licensing and Performance deposit for one year.

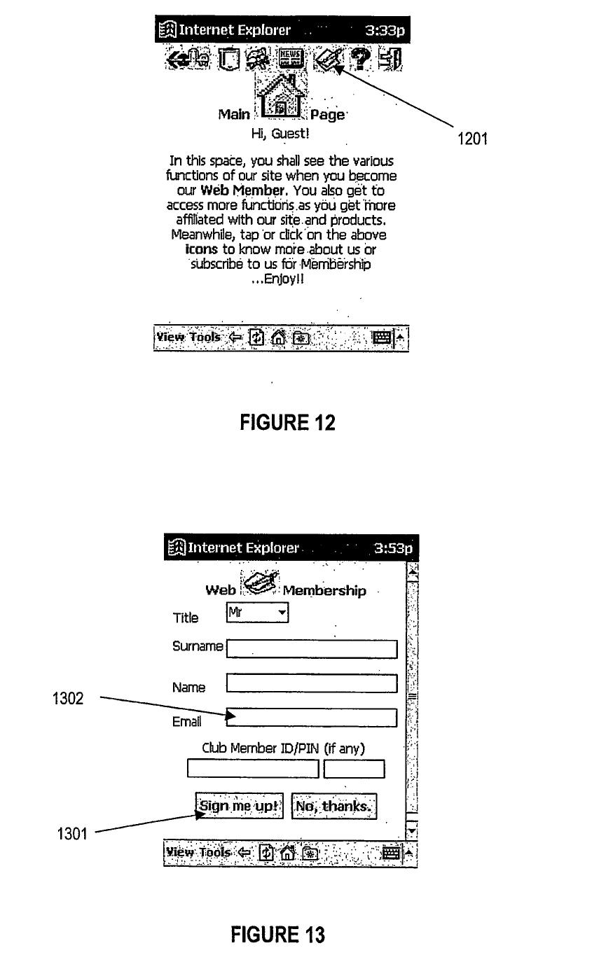

Before a Channel Partner or any User may start to use the Front-End System, they will be required to login to a designated web-site using their PC or Pocket PC to make their request as well as payment in order to obtain an EVENT-ID. The complete process of registration as a Channel Partner, through to the creation and activation of an Event, will now be described with reference to the accompanying FIGS. 12 to 23.

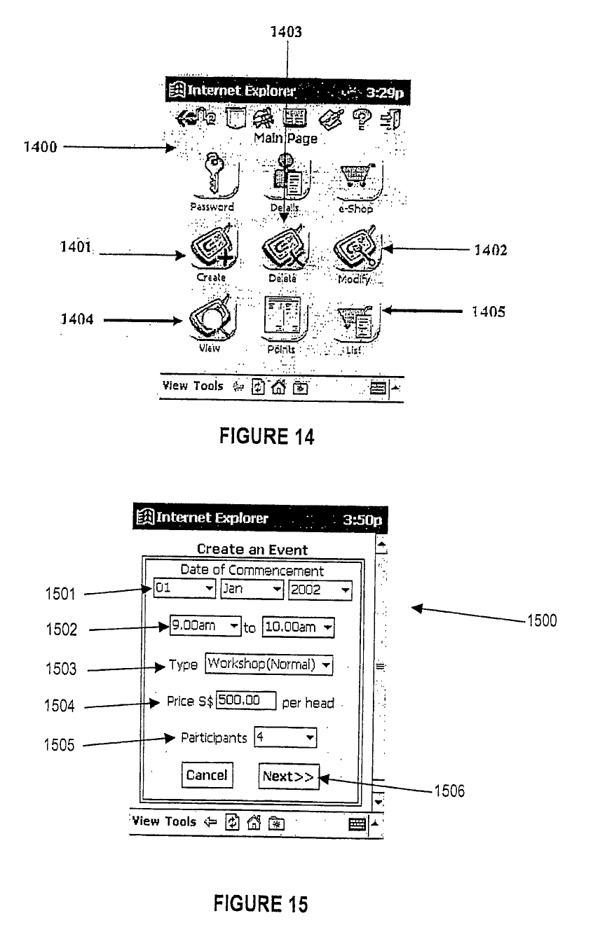

FIG. 12 shows the main web page that is presented to a user when first accessing the Back-End system via the World Wide Web using web browser software running on a PDA. By selecting the registration icon 1201, the user will be directed to the sign-up page shown in FIG. 13. This page allows the user to enter their personal details. Once the details are entered, the user selects the “Sign me up!” button 1301, and an email will be sent to the address specified in the email field 1302 asking the user to confirm their interest in registering as a Web member of the system. The user is then supplied with a password, and can then enter the Web site using the combination of email address and password. This brings the user to the main menu page 1400 shown in FIG. 14.

A user may become a Channel Partner via an off-line application procedure, during which the investment transactions previously outlined take place. A Web user with the status of Channel Partner is able to create an Event by selecting the “Create” icon 1401 from the main menu page 1400.

To create an Event, the Channel Partner is directed to the Event Creation page 1500 depicted in FIG. 15. The Channel Partner must enter the Date and Time for the Event in the corresponding fields 1501, 1502 of the Web form. Different Event types may be available, in which case the desired type may be selected from a drop-down list 1503. The cost per participant for the Event is shown in the Price field 1504. This cost will be determined by a separate agreement between the Back-End server operator and the Channel Partner. The Channel Partner also selects the number of participants in the Event from the provided field 1505, and then selects the “Next” button 1506 to move to the next stage of Event creation.

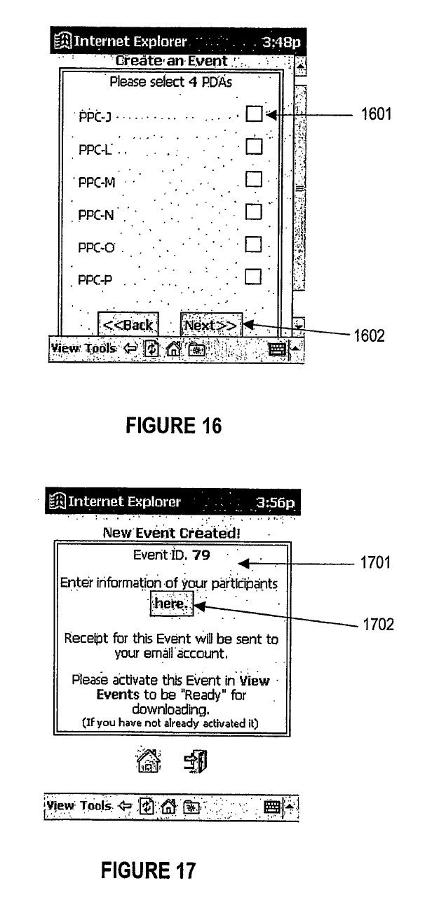

FIG. 16 shows the subsequent page, in which the Channel Partner will select the specific PDA devices to be used during the Event from a list corresponding to the set of devices purchased by the Channel Partner as part of the initial investment. Each device has a unique serial number, enabling the Back-End system to track the devices in use at any time, and prevent access by unauthorised devices. This also prevent a Channel Partner from “double-booking” any of their PDA devices, since the Back-End system retains a record of all scheduled use of the devices. The Channel Partner must select one device per participant by checking the boxes e.g. 1601, before moving on to the next screen using the “Next” button 1602.

At this point a new Event is created, and an Event-ID is allocated. At this stage, the Event is in fact only scheduled to occur. It must still be activated before it is ready for download by the participants. The web page displayed following the Event creation is illustrated in FIG. 17, and in this case the allocated Event-ID is “79”, as indicated in the event ID field 1701. The Channel Partner is then able to optionally enter information or other remarks relating to the expected participants in the Event by selecting the button 1702.

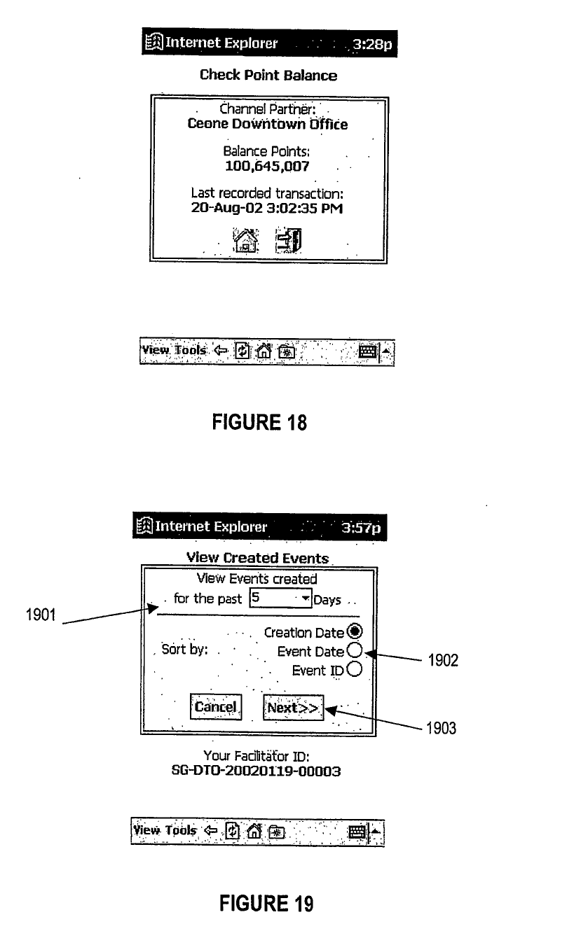

The participants will pay the Channel Partner directly for their participation in the Event. However, in the preferred embodiment the Channel Partner does not pay the Back-End server operator on an Event-by-Event basis. Rather, the Channel Partners purchase “points” from the server operator, and a points account is maintained for each Channel Partner. Each Event creation results in a deduction of a corresponding number of points from the Channel Partner's account, and a Channel Partner is able to view their current points balance by selecting the icon 1405 labeled “Points” from the Main Page 1400. The resulting points balance screen is depicted in FIG. 18.

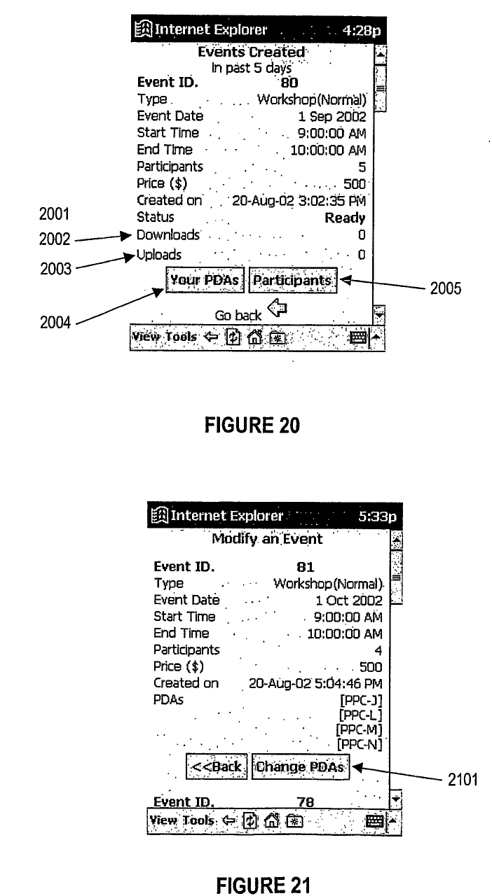

It is also possible for a Channel Partner to view a history of created Events by selecting an icon labeled “View” 1404 from the Main Page 1400. Doing so causes the page shown in FIG. 19 to be displayed. This form allows the Channel Partner to select the period of time over which the Events created should be listed using the time period field 1901, and to sort by creation date, event date or Event-ID using radio buttons 1902. Pressing the “Next” button 1903 causes the list to be displayed, as shown in FIG. 20.

The information displayed about each Event includes the information entered when the Event was created. It also includes an Event status line 2001, a record of the number of downloads 2002 and uploads 2003 that have taken place, if the Event has already commenced, and buttons 2004, 2005 to display the PDAs allocated to the Event and any comments that have been enetered regarding the participants. In the example shown in FIG. 20, the status 2001 is “Ready”, indicating that the Event has already been activated and is ready for participants to download. If the Event has not yet been activated, then an additional button (not shown) is included on this page to enable the Channel Partner to activate the Event. Once an Event has been activated, it cannot be modified or deleted, and no refund of the Channel Partner's points is possible.

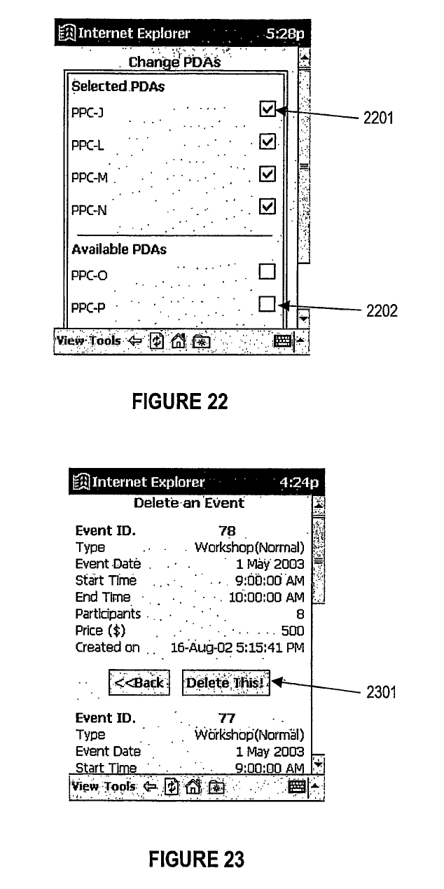

Prior to activation of an Event, it is possible for a Channel Partner to modify the Event by selecting the icon 1402 labeled “Modify” from the Main Page 1400. The resulting Event modification page is shown in FIG. 21. Again, the page includes the information that was entered when the Event was created. In the embodiment shown in FIG. 21, only the allocated PDAs can be changed, which is done by the Channel Partner selecting the “Change PDAs” button 2101. When this is done, the page shown in FIG. 22 is displayed, allowing the user to modify the set of PDAs allocated to the Event by unselecting any of the currently selected PDAs, e.g. PPC-J 2201, and selecting alternative PDAs from those still available, e.g. PPC-P 2202.

Prior to activation of an Event, it is also possible for a Channel Partner to delete the Event by selecting the icon 1403 labeled “Delete” from the Main Page 1400. The resulting Event deletion page is shown in FIG. 23. Again, the page includes the information that was entered when each Event was created. Only Events that have not yet been activated may be deleted. The Channel Partner may delete an Event by selecting the corresponding delete button. For example, on the page shown in FIG. 23, the Channel Partner may delete the Event with Event-ID 78 by selecting the button 2301 labeled “Delete This!”.

The discussion will now turn to a description of the use of the Front-End program to access the Back-End system during the course of an Event. Note that the Front-End program may be used by the Channel Partner, the instructor, and participants to access various features of the Back-End system.

All the Front-End systems that are going to be used in an Event must auto-synchronise with the Web-site using the corresponding Event-ID. The Event-ID serves to identify the Event and as a form of Front-End system security. It is used to turn on the system, and is only valid for the date and time for which the Event was scheduled, and in conjunction with the PDAs that were allocated for use with the Event.

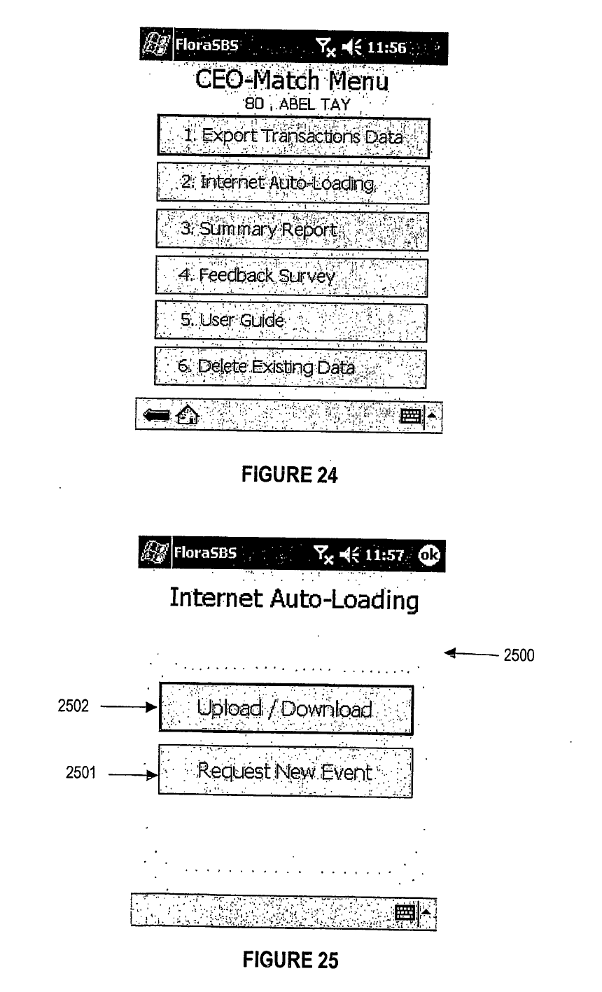

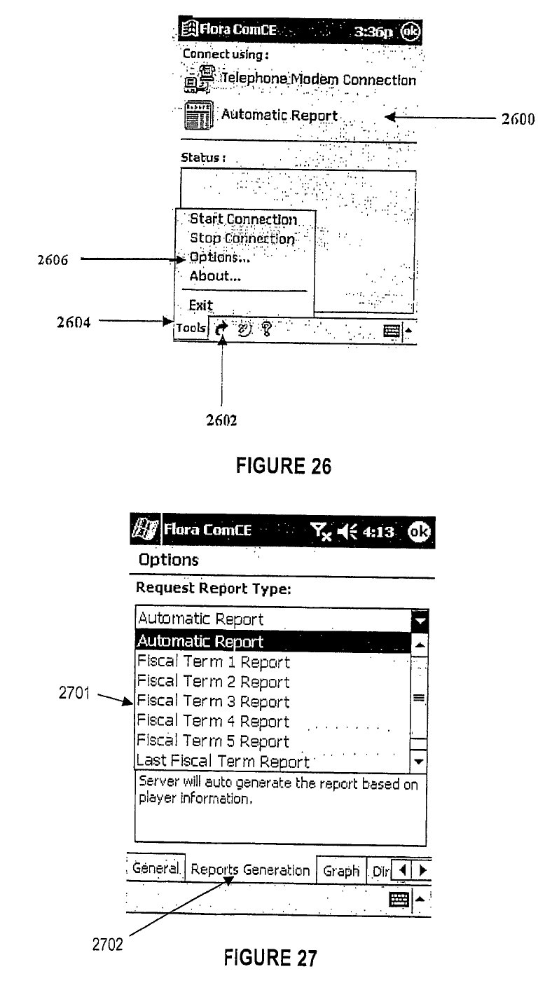

In the preferred embodiment, the Front-End program includes a main menu. A Front-End system display corresponding to this menu is shown in FIG. 24. To enable data transfer with the Back-End system, the user selects the button 2402 corresponding to item 2 on the menu, “Internet Auto-Loading”. This causes the screen 2500 shown in FIG. 25 to be displayed. By pressing the button 2501 labeled “Request New Event” the user will be able to enter the Event-ID of an activated Event, and download the data corresponding to the Event from the Back-End system to the Front-End system. When connecting to the Back-End server, the screen 2600 shown in FIG. 26 is displayed. Selecting the arrow 2602 activates the connection to the server, causing the selected data to be downloaded.

One the Front-End system preparation is completed on each allocated PDA, by selecting and downloading the Event data from the Back-End server, participants will experience a year of business simulation and input transactions in accordance with the learning system, as described previously. At the end of the Fiscal Year of simulated operations, participants export the data to the Back-End system via the Internet for processing. This is done by selecting the “Upload/Download” button 2502 from the “Internet Auto-Loading” screen 2500. The connection screen 2600 will again be displayed, and the user connects to the Back-End server to complete the upload by selecting the arrow 2602. The user can select the required upload options by selecting the “Tools” button 2604 in the command bar, which causes a menu 2606 to be displayed. Selecting the “Options” item from this menu enables the user to select upload options.

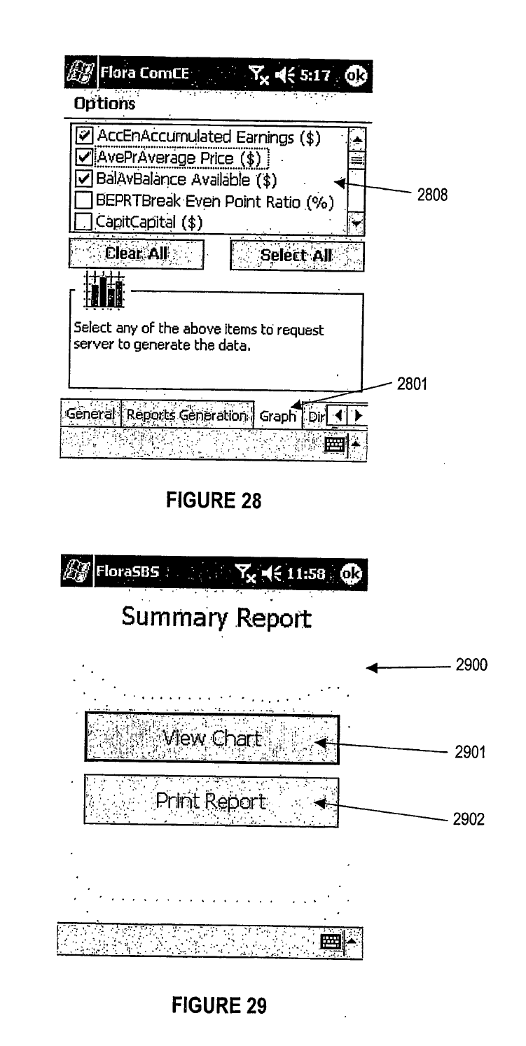

Once all participants have uploaded their data to the Back-End server, the server consolidates all data, and the resulting reports and charts are then available for download to the instructor and participants' PDAs running the Front-End program. This facility is again accessed using the “Upload/Download” button 2502 on the “Internet Auto-Loading” screen 2500. The information to be downloaded can then be selected via the “Tools” button 2604 on the connection screen 2600. This enables the user to activate an “Options” screen, examples of which are shown in FIGS. 27 and 28.

In the preferred embodiment, the “Options” screen has a number of tabs that are used to select different upload and download options. The “Options” display shown when the “Report Generation” tab 2702 is selected is shown in FIG. 27. This screen enables the user to select a report to download. The user selects the required report from the list 2701 on this screen. As shown, the report may be a PPA report corresponding to any selected Fiscal Year of the simulation.

The “Options” display shown when the “Graph” tab is selected is shown in FIG. 28. The user selects the desired graph data to download from the list 2802 of available graphs. The Back-End server will then generate the graph data corresponding to the user's selections.

Once the requested data (e.g. report data and/or graph data) has been downloaded from the Back-End server, the Front-End system displays the “Summary Report” screen 2900 as shown in FIG. 29. From this screen the user may choose to view charts of the graph data by selecting the “View Chart” button 2901 and/or print the PPA report by selecting the “Print Report” button 2902.

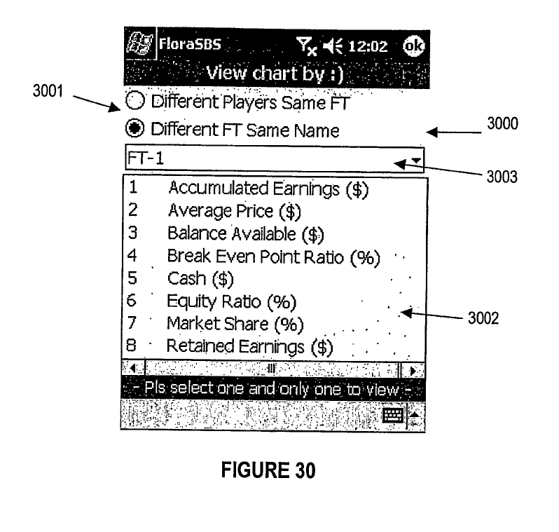

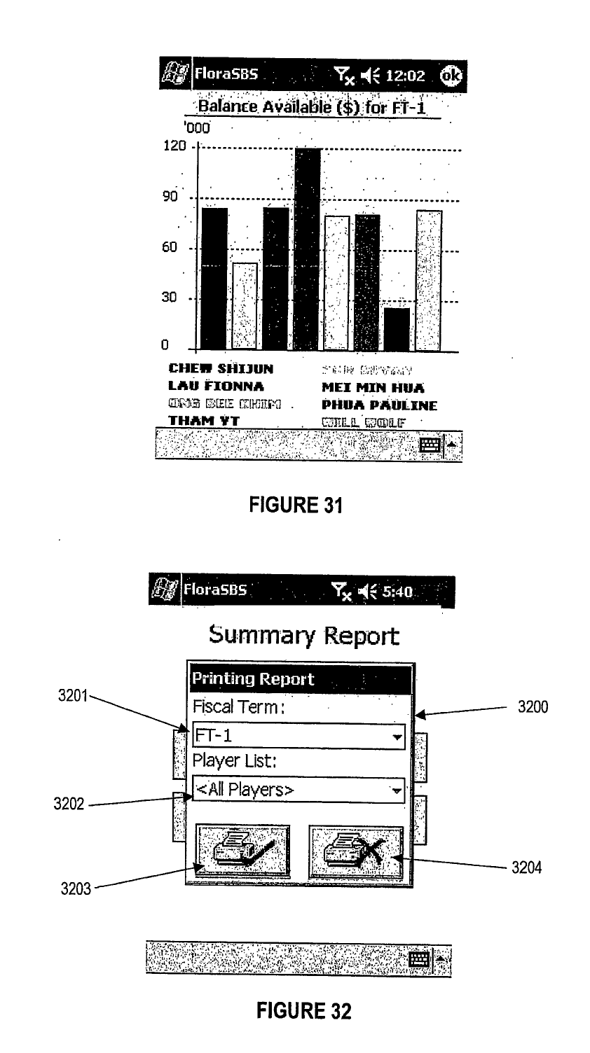

The “View Chart” screen 3000 generated by the Front-End program when the “View Chart” button 2901 is selected is shown in FIG. 30. At this screen, the user must select options so as to generate only one chart from all the possible charts that may be generated from the downloaded data. At the top of the screen, the user sets radio buttons 3001 to select whether the chart will show data for all the different participants during a single Fiscal Term (i.e. comparison between participants), or whether it will show data for a single participant over all available Fiscal Terms (i.e. comparison across years). One of the available types of information must then be chosen from the list 3002. If a chart is to be generated for a single Fiscal Term, then the user must also select the desired Fiscal Term from the drop-down list 3003. Once all the required options are selected, the Front-End system will display the corresponding chart. For example, FIG. 31 shows a chart generated for all participants in a single Fiscal Term FT-1, comparing the available balance of each participant.

If the user selects the “Print Report” button 2902 from the “Summary Report” screen 2900, the “Printing Report” dialog box 3200 is displayed, as shown in FIG. 32. This dialog box allows the user to select the Fiscal Term for which the report should be printed from a drop-down list 3201 of available Fiscal Terms, and the participants whose information should be included in the report from a second drop-down list 3202. Selecting the print button 3203 causes the printer selection dialog 3300 to be displayed. Printing may be canceled by selecting the cancel button 3204.

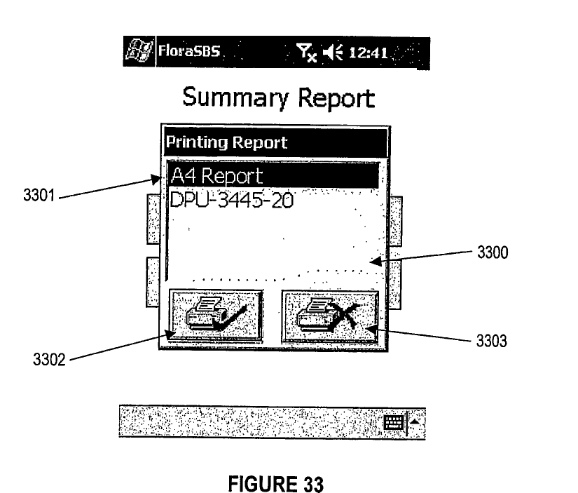

The printer selection dialog 3300 is shown in FIG. 33. The user is able to choose a printer from a list of available printers 3301, and then commence printing by selecting the print button 3302. Printing may be canceled by selecting the cancel button 3303. The connection between the PDA and the selected printer may be, for example, via an infrared wireless link.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A learning system including a computer assisted simulation of a business environment having at least one virtual marketplace common to all participants in which participants can simulate the trading of processed goods and/or raw materials, each participant having access to a computing means for maintaining a record of their simulated organisation and each participant being able to communicate with other participants, the system further including:
items representing raw materials, manpower and production facilities;
means for participants to review the actions executed in operating their simulated organisation; and
communication means enabling the individual actions of each participant in operating their simulated organisations to be compared and analysed.

2. A learning system as claimed in claim 1 wherein the actions of each participant in operating their simulated organisations is communicated to an instructor as well as other participants thus enabling the participant to understand the result of their actions and decisions and how their decisions could have been modified to produce a better result.

3. A learning system as claimed in claim 1 wherein each participant is able to communicate physically and directly with other participants.

4. A learning system as claimed in claim 1 wherein the business environment is simulated in rounds where each participant takes a turn and, at the completion of a round, the system provides to each participant a report of the result of the participants actions during the previous round.

5. A learning system as claimed in claim 4 wherein during each round the system provides each participant with one or more opportunities to make decisions, and wherein prior to the participant committing to a decision the system presents the participant with a learning message.

6. A learning system as claimed in claim 5 wherein an experienced business person or instructor assists the participants to understand the result of their decisions during the previous round and how their decisions could have been modified to produce a better result.

7. A learning system as claimed in claim 1 including a stylized map of the world to enable participants to monitor the location of assets owned by their simulated organisation.

8. A learning system as claimed in claim 7 wherein physical items representing different types of assets are placed onto the stylized map of the world to represent the acquisition and location of assets owned by a simulated organisation in the world.

9. A learning system as claimed in claim 8 wherein an item is also provided to represent services.

10. A learning system as claimed in claim 1 including a plurality of different sized markets with differing sets of minimum buying costs for raw materials and maximum selling prices for finished goods.

11. A learning system as claimed in claim 1 including items representing land and/or external branch offices.

12. A learning system as claimed in claim 11 wherein participants may purchase the items representing land and/or external branch offices for purposes of using these assets to increase the overall value of the simulated organisation.

13. A learning system as claimed in claim 1 wherein each participant's computing means is operable to display various types of information relevant to the learning system and receive instructions from the participant with respect to actions in accordance with business decisions taken by the participant.

14. A learning system as claimed in claim 1 wherein each participant is able to hide assets owned by the simulated organisation from other participants.

15. A learning system as claimed in claim 1 including a simulated central bank using electronic money from which each participant may obtain loans for the operation of their simulated organisations, said loans being administered by an instructor.

16. A learning system as claimed in claim 1 wherein, upon completion of a round, data is exported from the participants computing means and communicated to a central computing means.

17. A learning system as claimed in claim 16 wherein the central computing means is an Internet server.

18. A learning system as claimed in claim 16 wherein the central computing means is operable to perform analysis of the data received from the participants' computing means, and to generate reports that may be used by an instructor and/or the participants to analyse the participants' performance in the simulation.

19. A learning system as claimed in claim 18 wherein the reports include any one or more of the following:
a) reports on participants' performance during any past or the current fiscal term of the simulation;
b) reports comparing the year on year performance of a single participant;
c) reports comparing the participants' performance and market share during a single fiscal term.

20. A learning system as claimed in claim 18 or claim 9 wherein the reports include charts comparing selected performance factors either:
a) between different participants during the same fiscal term;
b) between different fiscal terms for the same participant.

21. A learning system as claimed in claim 20 wherein the performance factors that are available for selection include:
a) accumulated earnings;
b) average price;
c) balance available;
d) break even point ratio;
e) cash reserve;
f) equity ratio;
g) market share;
h) retained earnings.

22. A learning system as claimed in claim 1 wherein the computing means of the participants are operable to retrieve the reports from the central computing means, and to display the reports on a display of the computing means and/or to print the reports using an associated printing means.

23. A learning system as claimed in claim 1 wherein the computing means used by each participant is a Pocket PC or Personal Digital Assistant (PDA).

24. A learning system as claimed in claim 16 wherein the central computing means is adapted to maintain information relating to more than one simulation at any given time.

25. A learning system as claimed in claim 24 wherein the central computing means is operable by authorised users such as instructors or other facilitators, each of which is initially required to register as an operator of the central computing means in order to become authorised, and each of which is identified using a code allocated upon registration, such as a member identity number.

26. A learning system as claimed in claim 25 wherein an authorised user is able to operate the central computing means to schedule a simulation to occur at a specified time.

27. A learning system as claimed in claim 26 wherein a cost is associated with each simulation representing a price to be paid by each participant in order to participate in the simulation.

28. A learning system as claimed in claim 27 wherein the central computing means maintains a virtual account for each authorised user, the account containing points corresponding to monetary payments, and the number of points in the user's account is being checked by the central computing means upon an attempt to schedule a simulation such that if the user has insufficient points, then the simulation will not be scheduled.

29. A learning system as claimed in claim 26 wherein a scheduled simulation must subsequently be activated by the authorised user before the simulation can commence, and wherein prior to activation a scheduled simulation may be cancelled, modified or activated by an authorised user.

30. A method of business learning including computer assisted simulation of a business environment having a virtual marketplace common to all participants in which participants can simulate the trading of processed goods and/or raw materials, each participant having access to a computing means where each participant maintains a record of their simulated organisation and each participant being able to communicate with other participants, the method including the steps of:
simulating the business environment in cycles where each participant takes a turn, and, at the commencement of a cycle, information relevant to the business environment is communicated to each of the participants and each participant takes individual turns to effect actions in an attempt to optimise the value of their simulated organisation for that cycle;
recording each participant's action in the computing means; and
communicating the actions of each participant with all other computing means,
such that the actions of each participant may be analysed and compared with the actions of other participants.

31. A learning method as claimed in claim 30 wherein an experienced business person or instructor assists participants to understand the result of their decisions during the previous round and how their decisions could have been modified to produce a better result.

32. A learning method as claimed in claim 30 including the step of:
selecting a market condition for each round and advising each participant of that condition that will prevail for that round.

33. A learning method as claimed in claim 30 including, during participation, the steps of:
participants purchasing raw materials from the virtual common market place;
processing those materials through a planning and design stage to produce finished goods;
processing the finished goods to a packing stage; and
placing those goods into the virtual common market for sale.

34. A learning method as claimed in claim 33 including, during participation the steps of:
purchasing processing facilities, manpower and raw materials to process and produce finished goods.

35. A learning method as claimed in claim 34 wherein finished goods sold to the market are recycled into raw materials which may be subsequently purchased.

36. A learning method as claimed in claim 30 wherein, upon the predetermined number of cycles being completed, the data from the participants computing means is uploaded to a central computing means operated by the instructor, said central computing means being operable to analyse the uploaded data and compare the actions of each participant in the operation of their respective simulated organisations.

37. A learning method as claimed in claim 30 wherein each participant receives a comprehensive debrief from the instructor with respect to the performance of their simulated organisation.

38. A computer program product including a computer usable medium having computer readable program code and computer readable system code embodied on the medium for assisting the simulation of a business environment having a virtual marketplace common to all participants in which participants can simulate the trading of processed goods and/or raw materials, each participant having access to a computing means, each participant being able to communicate with other participants, the computer program product further including computer readable code within the computer usable medium for:
maintaining a record of a participant's simulated organisation within the participant's computing means;
recording the participant's actions in the participant's computing means; and
communicating the actions of the participant with the computing means of all other participants.

39. A computer program product as claimed in claim 38 wherein the participant's actions include:
purchasing raw materials from the virtual common market place;
processing those materials through a planning and design stage to produce finished goods;
processing the finished goods to a packing stage; and
placing those goods into the virtual common market for sale.

40. A computer program product as claimed in claim 39 wherein the participant's actions further include purchasing processing facilities, manpower and raw materials to process and produce finished goods.

41. A computer program product as claimed in claim 38, the computer program product further including computer readable code within the computer usable medium for uploading data from the participant's computing means to a central computing means operated by the instructor, the central computing means being operable to analyse the uploaded data of all participants and compare the actions of each participant in the operation of their respective simulated organisations.

42. A computer program product including a computer usable medium having computer readable program code and computer readable system code embodied on the medium for assisting the simulation of a business environment having a virtual marketplace common to all participants in which participants can simulate the trading of processed goods and/or raw materials, each participant having access to a computing means, each participant being able to communicate with other participants, the computer program product further including computer readable code within the computer usable medium for:
downloading data from each participant's computing means;
analysing the downloaded data and comparing the actions of each participant in the operation of their respective simulated organisations.
